(19) United States
(12) Patent Application Publication
(10) Pub. No.: US 2016/0253317 A1
(43) Pub. Date: Sep. 1, 2016

(54) Message Translation Application

(71) Applicant: Yaniv Israel Bar, Tel Aviv (IL)

(72) Inventor: Yaniv Israel Bar, Tel Aviv (IL)

(21) Appl. No.: 14/634,835

(22) Filed: Mar. 1, 2015

(51) Int. Cl. G06F 17/28

(52) U.S. Cl. CPC G06F 17/289

(57) ABSTRACT

A smartphone message translation application for smartphones with Internet connection that enables to send text and voice messages from the one user's smartphone to another user's smartphone; wherein the said text or voice message is translated from the device language of the sender's smartphone to the device language of the receiver's smartphone.

### TECHNICAL FIELD

The present invention refers to a smartphone application for sending text and voice messages that includes a translation program that enables real-time translation of the messages from the device language of the user's smartphone to the device language of the receiver's smartphone.

### BACKGROUND ART

There are, currently, several messaging applications available for smartphones and selected cellular phones with internet connection, such as Line, Viber, WeChat, whatsApp and so on. Users of such messaging applications can use is their smartphones and the internet to send one another text messages, voice messages, photographs, their location, and so on. Any average expert in the area is familiar with these applications and knows how they are developed and operate, and there is no need to provide a detailed description of them in the present patent application. Users sometimes send text and/or voice messages to one another despite being located in different countries and not sharing a common language. In such cases, people obviously tend to write in English, which is an international language commonly used even in non-English-speaking countries. Alternately, the sender may copy the message and translate it into a language that is familiar to the receiver using an online translation program, or that the receiver may copy the incoming message and translate it into a language that he is familiar with. The same is true for voice messages sent through such messaging applications as well. The message translation application, subject of the present patent application, provides a good, effective, quick, and real-time response to the aforementioned problem.

### DESCRIPTION OF THE FIGURES

The intention of the figures attached to the application is not to limit the scope of the invention and its application. The figures are intended only to illustrate the invention and they constitute only one of its many possible implementations.

FIG. 1 presents a general diagram of the internet-based communications between two smartphones (10) (20) and corresponding servers (100).

### THE INVENTION

The main objective of the present patent application is to provide and describe a method, a system, a computer program, and a smart phone application (hereinafter the “Application” and/or “the Message Translation Application”) for smartphones and for selected telephone devices, stationery computers, and laptops with internet connection (hereinafter “Smartphones”). The Application is designed to enable users to send text and/or voice messages from one Smartphone to another wherein the text and/or voice message undergoes real-time translation from one language to another in a quick and efficient mariner.

Methods, systems, computer programs, and smartphone applications for sending text and voice messages are commonly known and have been available to the general public for quite a few years. In addition, methods, systems, and software programs that translate text and/or speech from one language to another are also already known and readily available. Specialists in the area are no doubt familiar with the structure and complexity of said programs and so there no need to present detailed information on such in the present patent application.

The Application, subject of the present patent application, comprises a text messaging application, a voice messaging application, and a translation application that can run simultaneously and harmoniously as part of the Application, subject of the present patent application.

The Application, subject of the present patent application, offers users the option of sending text and voice messages from one Smartphone (10) to another Smartphone (20) via servers (100) on which the Application runs.

The Application also includes a translation program that enables users to translate text and voice messages from one language to another. The Application enables any user who has installed it to send any another user who has also installed it a text or voice message in one language and have the receiver receive the text or voice message in another language. The Application in fact translates the text or voice message from the sender's device language to the receiver's device language. The term “device language” and the manner in which it is set are described below.

Setting the device language of the Smartphone on which the Application is installed can be done either manually by the user or automatically by the Application. When the device language is set manually, the user may select the device language from a list of languages in the relevant menu. When the device language is set automatically, an option that can also be the device's default setting, the Application can for example identifies the country in which the device is being operated and sets the device language according to the language spoken in that specific country.

The Application can run in “translation” mode or “non-translation” mode. Non-translation mode is useful, for instance, when a German-speaking user who lives in Germany wishes to communicate with an American user but no problem communicating (i.e. writing and reading messages) in English. If, on the other hand, the German-speaking user does not know, and cannot communicate in the language of the user he or she is communicating with, he or she may of course run the Application in translation mode.

Since the Application translates text messages from the sender's device language to the receiver's device language, users can write their message in their Smartphone's device language, which is naturally their mother tongue. The Application then identifies the receiver's device language and translates the text message from the sender's device language to the receiver's device language so that the receiver receives the message as translated into his or her device language. The Application also offers an option whereby the receiver receives the text message as it was originally written along with the translated version. All of the above applies, of course, both to text messages and to voice messages.

The Application enables the user to decide whether to use translation mode or non-translation mode, to select and change the device language, and to decide whether or not to receive the original text or voice message in addition to the translated message.

Another option the Application offers is the “self-message” mode that enable user to send themselves text and voice messages. When the user selects the self-message mode, he or she may also select the language into which the text or voice message will be translated. Thus, the Application enables users to write or record a message in one language, send it to themselves, and receive it in their own smartphone in another language. This option is designed to enable two people who are located in the same place to communicate through text or voice messages using the same Smartphone

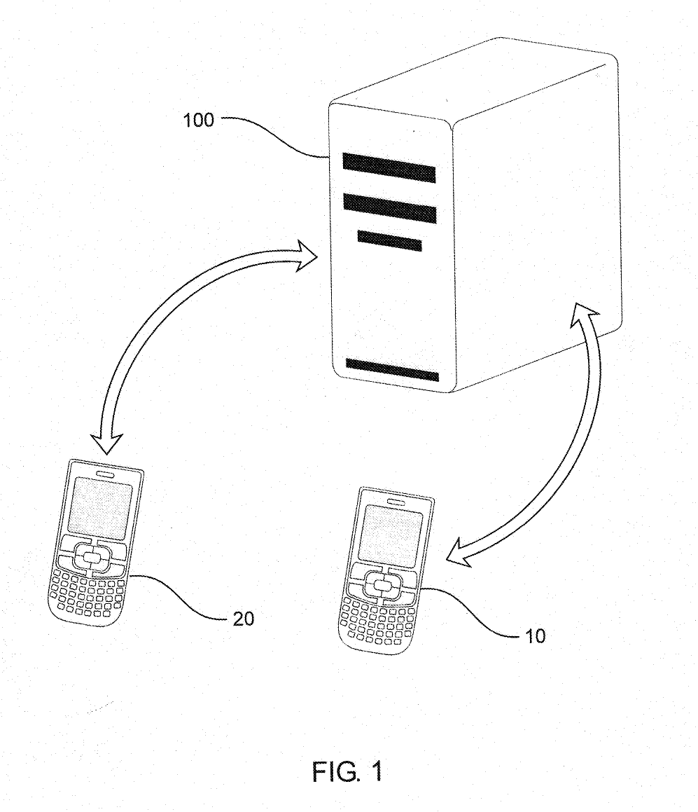

FIG. 1 presents a general diagram that schematically describes communications between one user's Smartphone (10) and another user's Smartphone (20) whereby communication is done through the server on which the Application runs. The Application includes communication with servers (100) that use the internee to transmit communications between Smartphones (10) (20) on which the Application is installed.

Application architecture in general: The Application operates on a peer-to-peer basis. Therefore, it will not open a connection (from a device) to any of the destination devices; instead, the device connects to a destination server. In order to create a connection, the Application can for example use a custom TCP protocol to communicate the messages to the server. The server then dispatches the messages to the appropriate destination devices. If the destination device has its Application open or at least has the Application process running, a live connection may be made with the server and the Application will use that connection to send the messages directly to the destination device.

The translation process may be executed before the message is sent from the server to its destination using, for example, one of the following protocols: (1) The sender defines the translation target language, and the server simply translates the incoming message into the requested language; (2) The sender wishes to use the local language of the destination device but does not know which language that is. In this case, the server must identify the local language configured on the destination device prior to translating the message. To do so, the server sends a single request (before the first translation process beings) to the destination device using TCP protocol (transparent to the clients), the destination Application returns a response with the detected language, and then the server translates the message and sends it to its destination. This language detection process will not be needed the next incoming messages.

The Application may also include an electronic mail application to enable the user to use the application for sending and receiving Email. Methods, systems, computer programs, and smartphone applications for sending and receiving Entails are commonly known and have been available to the general public for several years and there no need to present detailed information on such in the present patent application. The Application is therefore may also designed to enable users to send and receive Entails from one Smartphone to another wherein the text undergoes real-time translation from one language to another in a quick and efficient manner. The term “text messages” in the claim refers also to Entails messages sent and received by the application.

The Application may also include an option which enables the user to set the time on which he wishes that his message will be sent to the other smartphone. This option is mainly needed when two person are communicating and are locating in different time zones.

What is claimed is:

1. A message translation application for smartphones with internet connection that enables to send text and voice messages from a one user's smartphone to another user's smartphone; wherein said text or voice message is translated from a device language of the sender's smartphone to a device language of the receiver's smartphone; wherein the device language of the smartphone on which said application is installed can be configured manually by the user or automatically by the application itself; wherein said application can run in translation mode or in non-translation mode; wherein the application also includes an option of selecting a self-message mode that enables users to themselves text and voice messages and receive them after translation into another language.
